(19) United States
(12) Patent Application Publication
(10) Pub. No.: US 2026/0302409 A1
(43) Pub. Date: Oct. 1, 2026

(54) ENERGY STORAGE DEVICE

(71) Applicant: TOYOTA JIDOSHA KABUSHIKI KAISHA, Toyota-shi (JP)

(72) Inventors: Takaaki MATSUI, Seto-shi (JP); Taichi KATSUMOTO, Nagakute-shi (JP); Akinori KOKUBO, Toyohashi-shi (JP)

(73) Assignee: TOYOTA JIDOSHA KABUSHIKI KAISHA, Toyota-shi (JP)

(21) Appl. No.: 19/446,037

(22) Filed: Jan. 12, 2026

(30) Foreign Application Priority Data
Mar. 26, 2025 (JP) 2025-052551

(51) Int. Cl. H01M 10/653; H01M 10/613; H01M 10/625; H01M 10/647; H01M 50/103; B60L 50/64

(52) U.S. Cl. CPC H01M 10/653; H01M 10/613; H01M 10/625; H01M 10/647; H01M 50/103; B60L 50/64; H01M 2220/20

(57) ABSTRACT

The battery pack includes: at least one battery cell including a cell case; a battery case that houses the battery cell; and a thermally conductive material having a lower Young's modulus than the cell case and bonded to a bottom plate serving as the bottom of the cell case and a bottom plate serving as the bottom of the battery case. The bottom plate of the cell case has ribs. The thermally conductive material is bonded to the ribs.

### CROSS-REFERENCE TO RELATED APPLICATION

This application claims priority to Japanese Patent Application No. 2025-052551 filed on Mar. 26, 2025. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Japanese Unexamined Patent Application Publication No. 2024-114439 (JP 2024-114439 A) discloses a battery pack including: a battery module having a plurality of battery cells stacked in a prescribed direction; and a battery case housing the battery module.

In some cases, the bottom of the battery case and the bottoms of the individual battery cells are fixed together via a thermally conductive material that also serves as a highly thermally conductive adhesive. Accordingly, the disclosure of JP 2024-114439 A suppresses an increase in the temperature of each battery cell by transferring the heat generated by each battery cell to the battery case through the thermally conductive material.

### SUMMARY

When the internal pressure of a cell case rises, the cell case expands. At that time, the bottom of the cell case may deform into the interior space of the case. A thermally conductive material that serves to transfer heat from the battery cell to the lower case is bonded to the bottom of the cell case. Accordingly, when the bottom of the cell case deforms, the thermally conductive material may fail to follow the deformation and may peel off from the bottom. Once the thermally conductive material peels off from the bottom of the battery cell, heat transfer efficiency between the bottom and the thermally conductive material decreases. As a result, it becomes more difficult for heat from the battery cell to be transferred to the battery case through the thermally conductive material. This may reduce the efficiency of cooling the battery cell.

In view of the foregoing, an object of the present disclosure is to provide an energy storage device that can suppress a reduction in efficiency of cooling a battery cell even when the bottom portion of the cell case deforms into the interior space of the cell case.

An energy storage device of a first aspect includes: at least one battery cell including a cell case; a battery case that houses the battery cell; and a thermally conductive material having a lower Young's modulus than the cell case and bonded to a first bottom portion and a second bottom portion, the first bottom portion being a bottom portion of the cell case, and the second bottom portion being a bottom portion of the battery case. The first bottom portion of the cell case includes an uneven portion, and the thermally conductive material is bonded to the uneven portion.

In the energy storage device of the first aspect, the uneven portion to which the thermally conductive material is bonded is provided at the first bottom portion of the cell case. This increases the specific surface area of the first bottom portion. As a result, the bonding strength between the first bottom portion at which the uneven portion is formed and the thermally conductive material is improved. Accordingly, even when the cell case expands due to an increase in internal pressure and the bottom portion of the cell case deforms into the interior space of the cell case, the thermally conductive material is less likely to peel off from the member on which the uneven portion is formed. Therefore, even when the bottom portion of the cell case deforms into the interior space of the cell case, a reduction in the efficiency of cooling the battery cell by the thermally conductive material disposed between the first bottom portion of the battery cell and the second bottom portion of the battery case can be suppressed.

In the energy storage device of the first aspect, since the first bottom portion is provided with the uneven portion, the stiffness of the first bottom portion is improved. Accordingly, deformation of the first bottom portion is suppressed. As a result, separation between the first bottom portion and the thermally conductive material can be suppressed. Therefore, it is possible to suppress a reduction in the efficiency of cooling the battery cell by the thermally conductive material disposed between the first bottom portion of the battery cell and the second bottom portion of the battery case.

According to an energy storage device of a second aspect, in the first aspect, the uneven portion includes a plurality of ribs.

In the energy storage device of the second aspect, the uneven portion includes the ribs. Accordingly, the ribs improve the bonding strength between the first bottom portion of the cell case and the thermally conductive material, and the mechanical strength of the first bottom portion of the cell case.

According to an energy storage device of a third aspect, in the second aspect, the first bottom portion has, when viewed in an up-down direction, a rectangular shape having a pair of long sides and a pair of short sides, and the ribs extend along a direction parallel to the long sides.

In the energy storage device of the third aspect, the ribs improve the bonding strength between the first bottom portion of the cell case and the thermally conductive material.

According to an energy storage device of a fourth aspect, in the second aspect, the first bottom portion has, when viewed in an up-down direction, a rectangular shape having a pair of long sides and a pair of short sides, and the ribs extend along a direction parallel to the short sides.

In the energy storage device of the fourth aspect, the ribs suppress deformation of the first bottom portion into the interior space of the cell case caused by expansion of the cell case when its internal pressure increases. Accordingly, the thermally conductive material is less likely to peel off from the first bottom portion of the cell case, as compared with a case where the first bottom portion of the cell case undergoes large deformation into the interior space of the cell case.

According to an energy storage device of a fifth aspect, in the first aspect, the uneven portion includes a roughened surface.

In the energy storage device of the fifth aspect, the roughened surface increases the specific surface area of the second bottom portion. Therefore, the bonding strength between the first bottom portion of the cell case and the thermally conductive material can be improved.

According to an energy storage device of a sixth aspect, in any one of the first to fifth aspects, the first bottom portion has, when viewed in an up-down direction, a rectangular shape having a pair of long sides and a pair of short sides, and includes a first portion provided at a central portion in a direction parallel to the long sides and a second portion provided closer to end portions in the direction parallel to the long sides than the first portion. A vent valve configured to open when the internal pressure of the cell case reaches a predetermined value is provided at the first portion, and the uneven portion is provided at the second portion.

In the energy storage device of the sixth aspect, the vent valve and the uneven portion are provided at different portions of the first bottom portion (the first portion and the second portion, respectively). Accordingly, the vent valve can be smoothly opened when the internal pressure of the cell case of the battery cell reaches the predetermined value.

In the energy storage device of the sixth aspect, the vent valve is provided at the first portion of the first bottom portion, and the uneven portion is provided at the second portion of the first bottom portion. Accordingly, the area of the portion where the uneven portion is provided is smaller than in a case where, for example, the uneven portion is provided over the entire region of the first bottom portion. Even in such a case, the above configuration can improve the bonding strength with the thermally conductive material, and therefore the thermally conductive material is less likely to peel off from the first bottom portion of the cell case.

According to an energy storage device of a seventh aspect, in the sixth aspect, the uneven portion is provided at both end portions in the direction parallel to the long sides.

In the energy storage device of the seventh aspect, the uneven portion is provided at both end portions in the direction parallel to the long sides. Accordingly, the area where the uneven portion is provided is larger than in a case where, for example, the uneven portion is provided at one end portion in the direction parallel to the long sides. Therefore, the bonding strength between the first bottom portion of the cell case and the thermally conductive material can be improved.

As described above, the energy storage device according to the present disclosure can suppress a reduction in the cooling efficiency of the battery cell even when the bottom portion of the cell case deforms into the interior space of the cell case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view taken at a central portion in the vehicle width direction of a vehicle equipped with a battery pack according to a first embodiment;

FIG. 2 is a schematic exploded perspective view of the battery pack;

FIG. 3 is a schematic exploded perspective view of a lower case of a battery case and a battery module;

FIG. 4 is a schematic front view of a battery cell and a thermally conductive material;

FIG. 5 is a schematic cross-sectional view taken along line 5-5 in FIG. 4;

FIG. 6 is a schematic bottom view of a battery cell;

FIG. 7 is a schematic cross-sectional view taken along line 5-5 of FIG. 4, illustrating a state in which a battery cell has expanded;

FIG. 8 is a schematic bottom view, similar to FIG. 6, illustrating a battery cell of a battery pack according to a second embodiment;

FIG. 9 is a schematic cross-sectional view, similar to FIG. 7, illustrating a state in which a battery cell of the battery pack according to the second embodiment has expanded; and

FIG. 10 is a schematic bottom view, similar to FIG. 6, illustrating a battery cell of a battery pack according to a third embodiment.

### DETAILED DESCRIPTION OF EMBODIMENTS

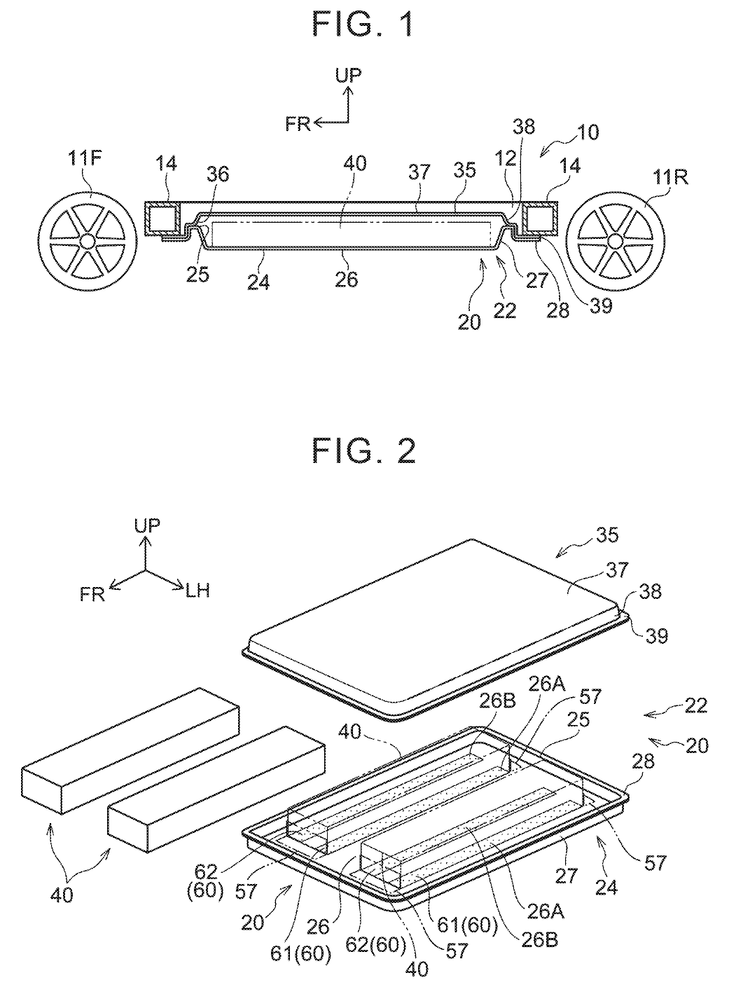

Embodiments of a battery pack (energy storage device) according to the present disclosure will be described below with reference to FIGS. 1 to 10. In the drawings, arrow FR indicates the forward direction in the vehicle front-rear direction, arrow LH indicates the leftward direction in the vehicle left-right direction, and arrow UP indicates the upward direction in the vehicle up-down direction. In the description below, the "front-rear direction," the "left-right direction," and the "up-down direction" refer to the vehicle front-rear direction, the vehicle width direction, and the vehicle up-down direction, respectively. The left-right direction refer to the left-right direction when facing forward of the vehicle.

### First Embodiment

As shown in FIGS. 1 and 2, a battery pack 20 of the present embodiment is mounted on a vehicle (electrified vehicle) 10. In the present embodiment, the vehicle 10 is a battery electric vehicle (BEV).

The vehicle 10 includes a pair of right and left front wheels 11F, a pair of right and left rear wheels 11R, a pair of right and left rockers 12 extending in the vehicle front-rear direction, and a pair of front and rear cross members 14 extending in the vehicle width direction (right-left direction) and each having its both ends fixed to the right and left rockers 12, respectively. The rockers 12 and the cross members 14 are among the vehicle body frame members.

The battery pack 20 of the present embodiment includes a battery case 22 and two battery modules 40. Electric power of the battery pack 20 (battery cells 43) is supplied to, for example, an electric motor (not shown) that applies a driving force to the front wheels 11F and the rear wheels 11R.

As shown in FIGS. 1 and 2, the battery case 22 includes a lower case 24 and an upper case 35.

The lower case 24 is a hollow body with an opening 25 formed at its upper side. The lower case 24 includes a bottom plate (second bottom portion) 26, a peripheral wall 27, and an outer peripheral flange 28. The peripheral wall 27 has an annular shape in plan, and the lower end of the peripheral wall 27 is joined to the outer peripheral edge of the bottom plate 26. The outer peripheral flange 28 also has an annular shape in plan, and the inner peripheral edge of the outer peripheral flange 28 is joined to the upper end of the peripheral wall 27. The lower case 24 may be made of, for example, metal.

The upper case 35 is a hollow body with an opening 36 formed at its lower side. The upper case 35 includes a top plate 37, a peripheral wall 38, and an outer peripheral flange 39. The peripheral wall 38 has an annular shape in plan, and the upper end of the peripheral wall 38 is joined to the outer peripheral edge of the top plate 37. The outer peripheral flange 39 also has an annular shape in plan, and the inner peripheral edge of the outer peripheral flange 39 is joined to the lower end of the peripheral wall 38.

As shown in FIG. 2, the two battery modules 40 are housed inside the lower case 24. The battery modules 40 are arranged side by side in the left-right direction. The battery modules 40 are placed on the bottom plate 26 of the lower case 24.

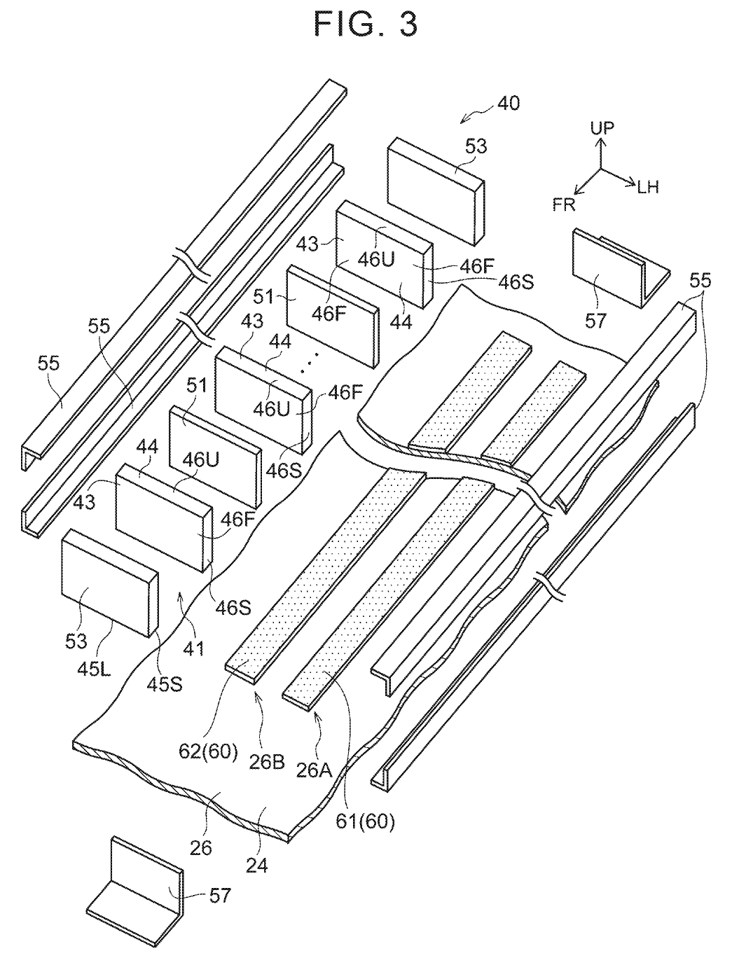

As shown in FIG. 3, the battery module 40 includes a battery stack 41, a pair of end plates 53, and four restraint members 55.

As shown in FIG. 3, the battery stack 41 extends in the vehicle front-rear direction as viewed in plan, and includes a plurality of battery cells 43 and a plurality of electrically insulating members 51 each disposed between corresponding adjacent battery cells 43. For convenience, three battery cells 43 are illustrated in FIG. 3. However, in practice, the battery stack 41 includes more than three battery cells 43.

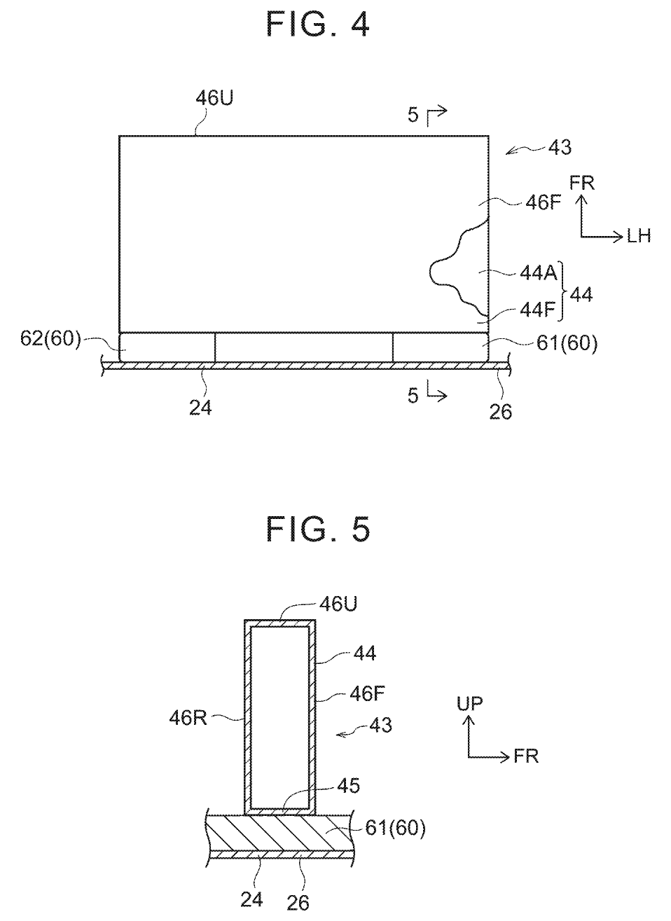

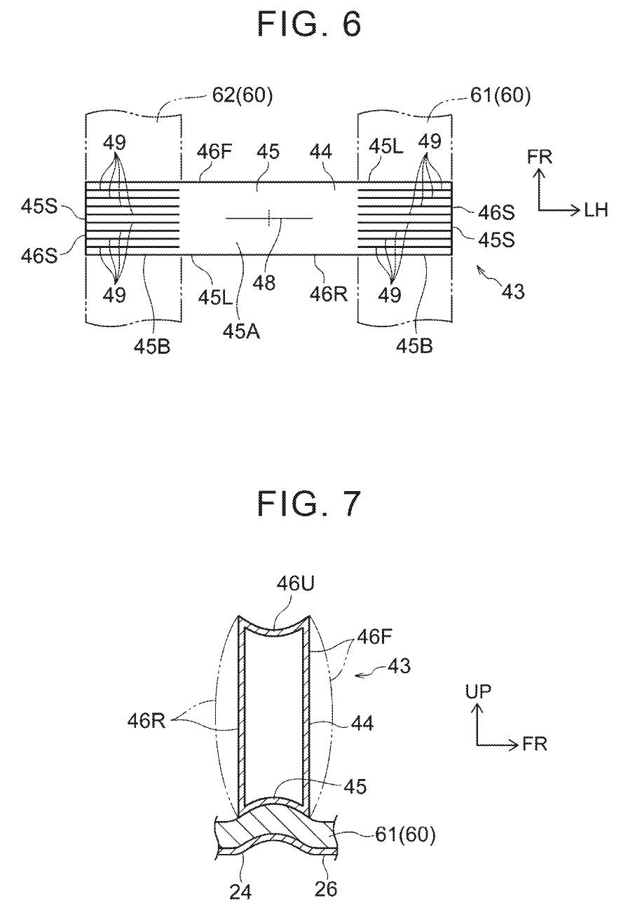

The battery cells 43 are lithium-ion cells, and as shown in FIG. 4, the external shape of each battery cell 43 is defined by a cell case 44, and the cell case 44 includes a metal case body 44A and an exterior film 44F that covers the entire surface of the case body 44A. The case body 44A has a rectangular parallelepiped shape. The exterior film 44F is bonded closely to the surface of the case body 44A while also conforming to a vent valve 48 and ribs 49 described later. The exterior film 44F may be made of, for example, polypropylene. The bottom of the case body 44A is formed by a bottom plate (first bottom portion) 45, and the top surface of the case body 44A is formed by an upper plate 46U. The bottom plate 45 and the upper plate 46U have a rectangular shape in plan that is longer in the left-right direction than in the front-rear direction. That is, as shown in FIG. 6, the outer shape of the bottom plate 45 is rectangular and includes a pair of short sides 45S and a pair of long sides 45L. The short sides 45S are parallel to the front-rear direction, and the long sides 45L are parallel to the left-right direction. Front and rear plates 46F, 46R of the case body 44A have the same shape when viewed from the front. Specifically, when viewed from the front, the front plate 46F and the rear plate 46R have a rectangular shape that is longer in the left-right direction than in the up-down direction. A positive electrode and a negative electrode (both not shown) are provided on left and right side plates 46S of the case body 44A.

As shown in FIG. 6, a vent valve 48 is provided at a central portion (first portion 45A) of the bottom plate 45 of the case body 44A in the left-right direction (that is, in the direction parallel to the long sides 45L). The vent valve 48 is a thin-walled portion in the shape of a plus sign. In other words, the mechanical strength of the vent valve 48 is lower than that of the portions of the bottom plate 45 other than the vent valve 48. When an internal short circuit occurs in the battery cell 43 and the internal pressure of the cell case 44 reaches a predetermined value, the vent valve 48 ruptures, that is, the vent valve 48 opens.

As shown in FIG. 6, a plurality of ribs (uneven portion) 49 projects downward from both end portions (second portions) 45B, in the left-right direction, of the bottom plate 45 of the case body 44A. The end portions 45B are located closer to the end portions in the right-left direction than the central portion 45A. When viewed in plan, each rib 49 extends parallel to the long sides 45L of the bottom plate 45. As is clear from FIG. 6, the ribs 49 on the right and left sides are arranged on the bottom plate 45 so as to avoid the vent valve 48.

As shown in FIG. 3, the battery module 40 includes the front and rear end plates 53. The front end plate 53 is positioned immediately in front of the foremost battery cell 43, and the rear end plate 53 is positioned immediately behind the rearmost battery cell 43.

As shown in FIG. 3, the four restraint members 55 extend in the front-rear direction and each has a generally L-shaped cross-section. Each restraint member 55 is placed at a corresponding one of the four corners of the battery stack 41. Each restraint member 55 covers the corner portions of the battery cells 43 (the cell cases 44) and front and rear end plates 53, and is fixed to the end plates 53. As a result, the length of each restraint member 55 in the front-rear direction becomes shorter than in its free state. In other words, the restraint members 55 pull the front and rear end plates 53 toward each other, and the front and rear end plates 53 therefore clamp the battery stack 41 from the front and rear. In this way, the battery stack 41 and the end plates 53 are integrated by the right and left restraint members 55. That is, the battery module 40 including the battery stack 41, the end plates 53, and the four restraint members 55 is completed.

The battery module 40 further includes a number of busbars (not shown) connected to the positive and negative electrodes of the battery cells 43.

As shown in FIGS. 2 and 3, each battery module 40 is housed inside the lower case 24 and is fixed to the bottom plate 26. Specifically, a liquid thermally conductive material 60 that also serves as an adhesive is applied to two regions 26A, 26B of the upper surface of the bottom plate 26. The regions 26A, 26B extend in the front-rear direction and are separated from each other. The thermally conductive material 60 may be, for example, an epoxy resin-based adhesive, a silicone rubber-based adhesive, a polyethylene-based adhesive, or a fluororesin-based adhesive. The dimensions of the regions 26A, 26B in the left-right direction are approximately the same as the dimensions of the ribs 49 on the cell cases 44 in the left-right direction. The dimensions of the regions 26A, 26B in the front-rear direction are approximately the same as the dimensions of the battery modules 40 in the front-right direction. The thermally conductive material 60 is applied over the entirety of each region 26A, 26B. That is, the thermally conductive material 60 includes a first thermally conductive portion 61 applied to the left-side region 26A and a second thermally conductive portion 62 applied to the right-side region 26B. The thermally conductive material 60 has high thermal conductivity. That is, the thermal conductivity of the thermally conductive material 60 is higher than that of the electrically insulating members 51.

As shown by the phantom lines in FIG. 2, the bottom of the left battery module 40 is placed on the region 26A, and the bottom of the right battery module 40 is placed on the region 26B. Accordingly, as shown in FIG. 6, the first thermally conductive portion 61 contacts the ribs 49 on the left side of the bottom plate 45 and the left-side portion of the bottom plate 45 of the cell case 44 of each battery cell 43, and the second thermally conductive portion 62 contacts the ribs 49 on the right side of the bottom plate 45 and the right-side portion of the bottom plate 45 of the cell case 44 of each battery cell 43. In other words, the vent valve 48 of each bottom plate 45 contacts neither the first thermally conductive portion 61 nor the second thermally conductive portion 62. When the thermally conductive material 60 cures, each battery module 40 is fixed to the regions 26A, 26B by the first and second thermally conductive portions 61, 62. The Young's modulus of the cured thermally conductive material 60 is lower than those of the lower case 24 and the cell case 44, and the cured thermally conductive material 60 is deformable.

As shown in FIG. 2, the end plates 53 of each battery module 40 are fixed to the bottom plate 26 via brackets 57 made of metal and having an L-shaped cross-section. Specifically, each end plate 53 is fixed by fastening means to the portion of the corresponding bracket 57 that extends in the up-down direction, and the lower end of each bracket 57 that extends in the horizontal direction is fixed by fastening means to the bottom plate 26. The fastening means may include, for example, a bolt that passes through the bracket 57, and internally threaded holes that are formed in the end plate 53 and the bottom plate 26 and into which the bolt can be screwed.

The outer peripheral flange 39 of the upper case 35 is placed, via a seal member (not shown), on the entire upper surface of the outer peripheral flange 28 of the lower case 24 housing the two battery modules 40, and the outer peripheral flange 28 and the outer peripheral flange 39 are fastened together. The battery pack 20 is completed in this manner.

As shown in FIG. 1, the battery case 22 of the completed battery pack 20 is supported by the rockers 12 and the cross members 14. That is, with the top plate 37 and peripheral wall 38 of the upper case 35 positioned in the space surrounded by the rockers 12 and the cross members 14, the outer peripheral flange 39 is fixed to the lower surfaces of the rockers 12 and cross members 14.

### Functions and Effects

The following functions and effects are achieved with the present embodiment.

For example, when the battery cells 43 of the battery modules 40 are supplying electric power to the electric motor, the battery cells 43 may become heated. A portion of the heat generated by each battery cell 43 is transferred from the right-side and left-side portions (the exterior film 44F) of the bottom plate 45 of the cell case 44 through the first and second thermally conductive portions 61, 62 to the bottom plate 26 of the lower case 24. In this manner, the first and second thermally conductive portions 61, 62 dissipate the heat of each battery cell 43 to the bottom plate 26, thereby suppressing excessive heating of the battery cells 43. That is, the battery cells 43 are cooled using the thermally conductive material 60.

If an internal short circuit occurs in any of the battery cells 43 of any battery module 40, the internal pressure of the cell case 44 increases, and as shown by the phantom lines in FIG. 7, the front plate 46F and the rear plate 46R may expand outward. In this case, due to the outward expansion of the front plate 46F and the rear plate 46R, the bottom plate 45 and the upper plate 46U may deform into the interior space of the cell case 44. That is, the bottom plate 45 may deform in such a manner that the region between the long sides 45L of the bottom plate 45 is displaced upward.

In the present embodiment, the ribs 49 are provided on the bottom plate 45 of the cell case 44. The ribs 49 increase the specific surface area of the bottom plate 45. Accordingly, the bonding strength between the bottom plate 45 and the thermally conductive material 60 is improved. Therefore, even when the bottom plate 45 of the cell case 44 of a battery cell 43 deforms into the interior space of the cell case 44, the thermally conductive material 60 is less likely to peel off from the bottom plate 45. As a result, even when the bottom plate 45 of the cell case 44 deforms into the interior space of the cell case 44, a reduction in the ability of the thermally conductive material 60, provided between the bottom plate 45 of each battery cell 43 and the bottom plate 26 of the lower case 24, to cool the battery cells 43, can be suppressed.

In the present embodiment, since the ribs 49 are provided on the bottom plate 45, the mechanical strength of the cell case 44 is higher than in the case where the entire lower surface of the bottom plate 45 is flat. The cell case 44 is therefore less likely to be damaged.

In the present embodiment, providing the ribs 49 on the bottom plate 45 increases the stiffness of the bottom plate 45. As a result, deformation of the bottom plate 45 is suppressed. Therefore, separation between the bottom plate 45 and the thermally conductive material 60 can be suppressed. Accordingly, it is possible to suppress a reduction in the efficiency of cooling the battery cell 43 by the thermally conductive material 60 provided between the bottom plate 45 of the battery cell 43 and the bottom plate 26 of the lower case 24.

In the present embodiment, the ribs 49 and the vent valve 48 are located at different positions when the battery cell 43 is viewed in the up-down direction, and the thermally conductive material 60 does not contact the region of the bottom plate 45 where the vent valve 48 is provided (see FIGS. 4 and 6). Therefore, when the internal pressure of the cell case 44 of the battery cell 43 reaches a predetermined value, the vent valve 48 smoothly opens, and the materials (debris) contained inside the cell case 44 are smoothly discharged to the outside of the battery cell 43 through the vent valve 48 and the ruptured region of the exterior film 44F corresponding to the vent valve 48. The materials (debris) contained inside the cell case 44 include, for example, internal electrodes (current-collecting terminals), electrolyte solution, and gas.

As described above, the battery pack 20 of the present embodiment has a structure in which the vent valve 48 can be smoothly opened when the internal pressure of the cell case 44 of a battery cell 43 reaches a predetermined value. In addition, even when the bottom plate 45 of the cell case 44 deforms into the interior space of the cell case 44, a reduction in the ability of the thermally conductive material 60 to cool the battery cells 43 can be suppressed.

### Second Embodiment

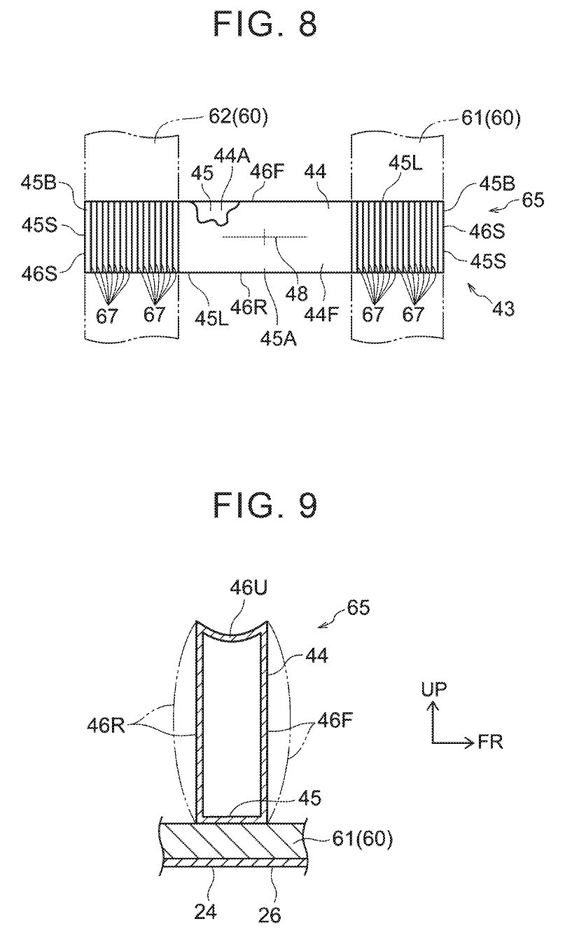

A second embodiment of the present disclosure will now be described with reference to FIGS. 8 and 9. The second embodiment differs from the first embodiment in the shape of the ribs provided on the bottom plate 45. The following description focuses mainly on the differences from the first embodiment. The same components as those in the first embodiment are denoted by the same signs as those in the first embodiment, and detailed description thereof will be omitted.

As described above, a battery pack 65 of the present embodiment differs from the first embodiment in the shape of ribs (uneven portion) 67 formed on the bottom plate 45 of the cell case 44 of each battery cell 43.

As shown in FIG. 8, a plurality of ribs 67 projects downward from both right-side and left-side portions of the bottom plate 45 of the cell case 44. When viewed in plan, each rib 67 extends parallel to the short sides 45S of the bottom plate 45. As is clear from FIG. 8, the ribs 67 on the right and left sides are arranged on the bottom plate 45 so as to avoid the vent valve 48.

As shown by the phantom lines in FIG. 8, in the second embodiment as well, the first thermally conductive portion 61 contacts the ribs 67 on the left side of the bottom plate 45 and the left-side portion of the bottom plate 45 of the cell case 44 of each battery cell 43, and the second thermally conductive portion 62 contacts the ribs 67 on the right side of the bottom plate 45 and the right-side portion of the bottom plate 45 of each battery cell 43. In other words, the vent valve 48 of each bottom plate 45 contacts neither the first thermally conductive portion 61 nor the second thermally conductive portion 62. When the thermally conductive material 60 cures, each battery module 40 is fixed to the regions 26A, 26B by the first and second thermally conductive portions 61, 62. In addition, each battery module 40 is fixed to the regions 26A, 26B by the brackets 57 (see FIG. 3).

The following functions and effects are achieved with the present embodiment.

In the second embodiment as well, if an internal short circuit occurs in any of the battery cells 43 of any battery module 40, the internal pressure of the cell case 44 increases, and as shown by phantom lines in FIG. 9, the front plate 46F and the rear plate 46R may expand outward. In this case, due to this expansion of the front plate 46F and the rear plate 46R, the upper plate 46U may deform into the interior space of the cell case 44. Furthermore, due to this expansion, the bottom plate 45 also tends to deform into the interior space of the cell case 44. However, the ribs 67 provided on the right-side and left-side portions of the bottom plate 45 suppress deformation of the right-side and left-side portions of the bottom plate 45 into the interior space of the cell case 44. In other words, since the ribs 67 extending parallel to the short sides 45S are provided on the right-side and left-side portions of the bottom plate 45, the bending stiffness of the right-side and left-side portions of the bottom plate 45 against upward deformation is higher than in the case where the entire lower surface of the bottom plate 45 is flat, and is also higher than in the first embodiment. Accordingly, as shown in FIG. 9, the left-side and right-side portions of the bottom plate 45 undergo little deformation at that time. Therefore, the thermally conductive material 60 (the first thermally conductive portion 61 and the second thermally conductive portion 62) fixed to the right-side and left-side portions of the bottom plate 45, and the regions of the bottom plate 26 of the lower case 24 located directly below the right-side and left-side portions of the bottom plate 45, also undergo little deformation. With this configuration, compared with the case where the right-side and left-side portions of the bottom plate 45 of the battery cell 43 undergo large upward deformation, the right-side and left-side portions of the bottom plate 45 and the bottom plate 26 of the lower case 24 are less likely to peel off from the thermally conductive material 60. As a result, even when the front plate 46F and the rear plate 46R of a battery cell 43 expands outward, a reduction in the ability of the thermally conductive material 60, provided between the bottom plate 45 of each battery cell 43 and the bottom plate 26 of the lower case 24, to cool the battery cells 43, can be suppressed.

In the present embodiment as well, the ribs 67 and the vent valve 48 are located at different positions when the battery cell 43 is viewed in the up-down direction, and the thermally conductive material 60 does not contact the region of the bottom plate 45 where the vent valve 48 is provided (see FIGS. 4 and 8). Accordingly, the vent valve 48 smoothly opens when the internal pressure of the cell case 44 of a battery cell 43 reaches a predetermined value. As a result, the materials (debris) contained inside the cell case 44 can be smoothly discharged to the outside of the battery cell 43 through the vent valve 48.

As described above, the battery pack 65 of the present embodiment also has a structure in which the vent valve 48 can be smoothly opened when the internal pressure of the cell case 44 of a battery cell 43 reaches a predetermined value. In addition, even when the bottom plate 45 of the cell case 44 deforms into the interior space of the cell case 44, a reduction in the ability of the thermally conductive material 60 to cool the battery cells 43 can be suppressed.

### Third Embodiment

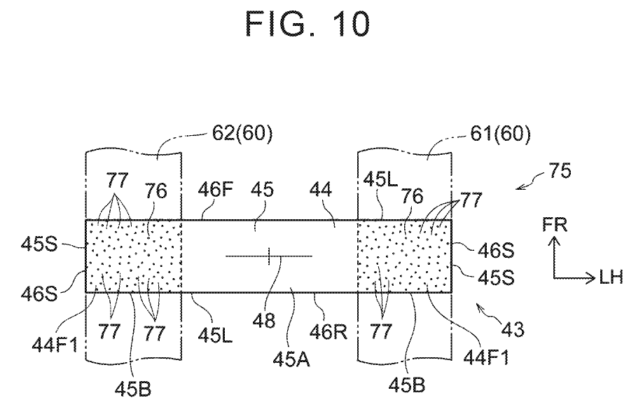

A third embodiment of the present disclosure will now be described with reference to FIG. 10. The third embodiment differs from the first embodiment in that a roughened surface is provided on the bottom plate 45 instead of ribs. The following description focuses mainly on the differences from the first embodiment. The same components as those in the first embodiment are denoted by the same signs as those in the first embodiment, and detailed description thereof will be omitted.

As described above, a battery pack 75 of the present embodiment is different from the first and second embodiments in that no ribs 49 or 67 are provided on the bottom plate 45 of each battery cell 43 and, instead of the ribs 49, 67, a roughened surface (uneven portion) 76 is provided on the portions of the exterior film 44F that cover the right-side and left-side portions of the bottom plate 45. Hereinafter, the portions of the exterior film 44F that cover the right-side and left-side portions of the bottom plate 45 are referred to as side portions 44F1.

As shown in FIG. 10, numerous irregularities 77 are formed on the left and right side portions 44F1 of the exterior film 44F. The irregularities 77 constitute the roughened surfaces 76. The left and right roughened surfaces 76 are provided on the bottom plate 45 so as to avoid the vent valve 48.

As shown by the phantom lines in FIG. 10, in the present embodiment as well, the first thermally conductive portion 61 contacts the roughened surface 76 on the left side of the cell case 44 of each battery cell 43, and the second thermally conductive portion 62 contacts the roughened surface 76 on the right side of the cell case 44 of each battery cell 43. In other words, the vent valve 48 of each bottom plate 45 contacts neither the first thermally conductive portion 61 nor the second thermally conductive portion 62. When the thermally conductive material 60 cures, each battery module 40 is fixed to the regions 26A, 26B by the first and second thermally conductive portions 61, 62. In addition, each battery module 40 is fixed to the regions 26A, 26B by the brackets 57 (see FIG. 3).

The following functions and effects are achieved with the present embodiment.

In the present embodiment as well, if an internal short circuit occurs in any of the battery cells 43 of any battery module 40, the internal pressure of the cell case 44 increases, and the bottom plate 45 and the upper plate 46U may deform into the interior space of the cell case 44. However, the roughened surfaces 76 to which the first thermally conductive portion 61 and the second thermally conductive portion 62 are bonded are respectively formed on the left and right side portions 44F1 of the exterior film 44F that cover the bottom plate 45. Accordingly, the lower surface of the bottom plate 45 (the exterior film 44F) has a greater specific surface area than in a case where it is a flat (smooth) surface. As a result, the bonding strength between the first thermally conductive portion 61 and the left side portion 44F1 (the roughened surface 76) of the bottom plate 45, and the bonding strength between the second thermally conductive portion 62 and the right side portion 44F1 (the roughened surface 76) of the bottom plate 45, increase. Accordingly, in this case, the first thermally conductive portion 61 that is in contact with the left side portion 44F1 (the roughened surface 76) of the cell case 44 of each battery cell 43 bends so as to become upwardly convex following the deformation of the bottom plate 45. Similarly, the second thermally conductive portion 62 that is in contact with the right side portion 44F1 (the roughened surface 76) of the cell case 44 of each battery cell 43 bends so as to become upwardly convex following the deformation of the bottom plate 45. As a result, the regions 26A, 26B of the lower case 24 to which the first thermally conductive portion 61 and the second thermally conductive portion 62 are bonded also bend so as to become upwardly convex. Since the regions 26A, 26B deform in response to the deformation of the respective side portions 44F1, the thermally conductive material 60 is less likely to peel off from the left and right side portions (exterior film 44F) of the bottom plate 45 and from the bottom plate 26 of the lower case 24, even when the bottom plate 45 of the cell case 44 of a battery cell 43 deforms into the interior space of the cell case 44. Therefore, in the battery pack 75 of the third embodiment, even when the bottom plate 45 of the cell case 44 deforms into the interior space of the cell case 44, a reduction in the ability of the thermally conductive material 60, provided between the bottom plate 45 of each battery cell 43 (the exterior film 44F) and the bottom plate 26 of the lower case 24, to cool the battery cells 43 can be suppressed.

In the present embodiment as well, the right and left roughened surfaces 76 are provided on the bottom plate 45 so as to avoid the vent valve 48. Accordingly, the vent valve 48 smoothly opens when the internal pressure of the cell case 44 of a battery cell 43 reaches a predetermined value. As a result, the materials (debris) contained inside the cell case 44 can be smoothly discharged to the outside of the battery cell 43 through the vent valve 48.

As described above, the battery pack 75 of the present embodiment also has a structure in which the vent valve 48 can be smoothly opened when the internal pressure of the cell case 44 of a battery cell 43 reaches a predetermined value. In addition, even when the bottom plate 45 of the cell case 44 deforms into the interior space of the cell case 44, a reduction in the ability of the thermally conductive material 60 to cool the battery cells 43 can be suppressed.

Although the energy storage devices according to the embodiments have been described above, various design modifications may be made without departing from the spirit and scope of the disclosure.

For example, each of the above embodiments illustrates an example in which the thermally conductive material 60 is attached to portions (right-side and left-side portions in the vehicle width direction) of the bottom plate 45 of the cell case 44. However, the present disclosure is not limited to this. For example, the thermally conductive material 60 may be attached to the entire bottom plate 45 of the cell case 44. In this case, the ribs 49, 67 or the roughened surfaces 76 may be provided over the entire bottom plate 45 of the cell case 44. When the thermally conductive material 60 is bonded to the entire bottom plate 45 of the cell case 44, the vent valve 48 may be provided at a location other than the bottom plate 45 (e.g., at the upper plate 46U or the side plates 46S).

For example, the battery pack may include three or more battery modules.

For example, the number of battery cells included in each battery module is not limited to any particular value.

For example, instead of the thermally conductive material 60, a deformable thermally conductive material different from an adhesive may be brought into contact with the bottom plate 45 of the cell case 44 and the bottom plate 26 of the lower case 24.

For example, the stacking direction of the battery cells in the battery pack (i.e., the extension direction of the battery modules) may be a direction different from the vehicle front-rear direction. The arrangement direction of the battery modules may be a direction different from the vehicle left-right direction.

For example, the vehicle may be an electrified vehicle equipped with an electric motor that uses power from the battery pack, rather than a battery electric vehicle (BEV). For example, the vehicle may be a hybrid electric vehicle (HEV) or a plug-in hybrid electric vehicle (PHEV).

What is claimed is:

1. An energy storage device comprising:
at least one battery cell including a cell case;
a battery case that houses the battery cell; and
a thermally conductive material having a lower Young's modulus than the cell case and bonded to a first bottom portion and a second bottom portion, the first bottom portion being a bottom portion of the cell case, and the second bottom portion being a bottom portion of the battery case, wherein:
the first bottom portion of the cell case includes an uneven portion; and
the thermally conductive material is bonded to the uneven portion.

2. The energy storage device according to claim 1, wherein the uneven portion includes a plurality of ribs.

3. The energy storage device according to claim 2, wherein:
the first bottom portion has, when viewed in an up-down direction, a rectangular shape having a pair of long sides and a pair of short sides; and
the ribs extend along a direction parallel to the long sides.

4. The energy storage device according to claim 2, wherein:
the first bottom portion has, when viewed in an up-down direction, a rectangular shape having a pair of long sides and a pair of short sides; and
the ribs extend along a direction parallel to the short sides.

5. The energy storage device according to claim 1, wherein the uneven portion includes a roughened surface.

6. The energy storage device according to claim 1, wherein:
the first bottom portion has, when viewed in an up-down direction, a rectangular shape having a pair of long sides and a pair of short sides, and includes a first portion provided at a central portion in a direction parallel to the long sides and a second portion provided closer to end portions in the direction parallel to the long sides than the first portion;
a vent valve configured to open when an internal pressure of the cell case reaches a predetermined value is provided at the first portion; and
the uneven portion is provided at the second portion.

7. The energy storage device according to claim 6, wherein the uneven portion is provided at both end portions in the direction parallel to the long sides.
